(19) United States
(12) Patent Application Publication
(10) Pub. No.: US 2019/0197378 A1
(43) Pub. Date: Jun. 27, 2019

(54) PHYSICAL COLD STORAGE TOKEN

(71) Applicant: Carson GARNER, Great Falls, VA (US)

(72) Inventor: Carson GARNER, Great Falls, VA (US)

(21) Appl. No.: 15/922,804

(22) Filed: Mar. 15, 2018

Related U.S. Application Data
(60) Provisional application No. 62/610,901, filed on Dec. 27, 2017.

(51) Int. Cl. G06K 19/06; G06Q 20/06; H04L 9/30; H04L 9/08

(52) U.S. Cl. CPC G06K 19/06037; H04L 9/088; H04L 9/30; G06Q 20/0658

(57) ABSTRACT

Provided are offline physical cold storage tokens that include a token shell, at least two internal layers within token shell, wherein each internal layer includes a private key or portion of a private key that is not visible when the token is assembled, and a top layer over said at least two internal layers. The tokens also include a visible public key, for example a stamp or engraving e.g., on a visible portion of the token shell or top layer. The tokens of the invention may also include one or more screws or other devices or mechanisms for holding the components and layers of the token together. Also provided are kits that include one or more components of the present physical tokens, and optionally include instructions and/or tools for assembling or securing the present tokens. Further provided are methods for assembling an offline cold storage token, in accordance with the present invention.

### RELATED APPLICATIONS

The present application claims the benefit of priority to U.S. Provisional Application No. 62/610,901 filed on Dec. 27, 2017, the contents of which are incorporated herein in their entirety.

### FIELD OF THE INVENTION

The present invention is generally directed to offline cold storage tokens for the storage of offline data variables in a physical form. The present tokens include a token shell, at least two internal layers positioned within the token shell, wherein each internal layer includes a private key or portion of a private key that is not visible when the token is fully assembled, and a top layer positioned and secured over the at least two internal layers. The token may also include a discoverable public key, for example on a visible portion of the token shell or top layer, or the key may be an RFID, scannable bar code or readable type. The tokens of the invention may also include one or more screws or other devices or mechanisms for holding the device together. Also provided are kits that include one or more components of the present devices, and optionally include instructions and/or tools for assembling the present tokens. Further provided are methods and systems for using offline cold storage of tokens with private keys, and methods and systems for assembling offline cold storage tokens, in accordance with the present invention.

An advantage of having a minimum of two separate internal layers to conceal the private key allows the division or splitting of the private variable or private data to make the separation and transport or storage of the private data more secure. A user wanting to use the private data would need all private layers each having private data such as a private key or partial private key to make use of the data or key. Once the private keys or partial private keys are combined, the user will be able to have the entire decryption key in physical form. A user can use additional layers to distribute the data or key across the disks. For example, the user can then mail or transport parts of the private key via three separate methods to keep the private data secure. The recipient can then reassemble the physical internal layers/disks to gain access to the full private data or key. Embodiments of the invention also have a public key in a readable or detectable form to present to another person or device to initiate a interaction, transaction, or computation. This will allow a user to interact with another using the publicly shown data and then at the user's choice show the private data concealed from view or detection.

### BACKGROUND OF THE INVENTION

Cryptocurrencies make it easier to transfer funds between two parties. These transfers are facilitated through the use of public and private keys for security purposes. Cryptocurrency and blockchain technology typically involve digital storage of a crypto private key. Bitcoin, which was created in 2009, was the first decentralized cryptocurrency, and is a visible application of blockchains. Bitcoin uses a block chain to store an online ledger of all the transactions that have ever been conducted using bitcoins, providing a data structure for this ledger that is exposed to a limited threat from hackers and can be copied across all computers running Bitcoin software. Bitcoin and other tokens and currencies based on distributed, cryptographical technology are collectively known as cryptocoins or cryptocurrency. The unifying factor among them all is the concept of the blockchain, and its ability to establish identity and ownership and record transactions.

Cryptocurrencies have drawbacks, however. A convenient way to store one's bitcoin and other cryptocurrency or altcoins (alternative coins) is in a digital wallet online, or locally on one's smartphone or computer. However, leaving your bitcoin key in public view or having it digitally accessible can open you up to attacks from hackers and phishing scams. This method is at high risk for digital theft of the cryptocurrency. Even if storage is done offline, then the USB key fob device or other digital storage device, can easily be destroyed by water, fire, or other natural disasters.

Additionally, because cryptocurrencies are virtual and do not have a central repository, a digital cryptocurrency balance can be wiped out by a computer crash if a backup copy of the holdings does not exist.

A further drawback with cryptocurrencies is that if you lose your digital private key you lose your money.

### SUMMARY OF THE INVENTION

The present invention is directed to solving the problems with cryptocurrency, in providing offline cold storage tokens, to assemble and keep data in a physical form that is resistant to physical destruction or loss. In particular, the present inventor has invented a physical token that stores private and public keys offline in a physical form; and is provided in multiple parts allowing data separation and concealment of data for further security, which parts can be assembled e.g. by the owner, after receiving all the physical parts, for storage.

The present invention is directed to offline cold storage tokens, that includes a token shell, at least two internal layers positioned within the token shell, wherein each internal layer includes a private key or portion of a private key that is not visible when the token is assembled, and a top layer positioned and secured over said at least two internal layers. The token may also include a discoverable public key. The discoverable public key may be a visible key on a visible portion of the token shell or on the top layer.

According to non-limiting example embodiments, the at least two internal layers include at least three internal layers, or at least four internal layers, or more layers. The at least two internal layers may be made e.g. of copper and may be generally in the shape of a disk, or other suitable shape for stacking together. The discoverable public key may be for example, engraved, printed or stamped on the token shell or have a discoverable RFID, barcode or decodable method for determining the public key. Similarly, the private key or portion of a private key may be engraved, printed or stamped or otherwise applied to the at least two internal layers.

According to example embodiments, the present tokens may also include at least one securing mechanism, such as a screw or other fastener. In example embodiments, all of the parts of the token (e.g. the token shell, at least two internal layers, and the top layer) may be configured to received one or more screws or other fastening devices that are capable of securing the layers within the token shell.

Another mechanism for securing the components of the token together may include inserting protrusions from the top layer in a slit of the token shell, to secure the layers together and prevent the token from disassembling. The top layer of the token may be configured such that it has one or more protrusions adapted to be rotated into a slit within the token shell to secure the top layer to the token shell with the at least two internal layers therebetween.

The tokens of the present invention may further include a tamper resistant component or device, such as a tamper resistant epoxy. The epoxy may be added e.g., over said securing mechanism (e.g. screw), so one can determine if the screw has been unscrewed and the token disassembled.

Also included herein are kits that include a token shell, at least two internal layers adapted to fit within the token shell, a top layer adapted to fit over said at least two internal layers, and optionally a discoverable public key on a portion of the token shell or top layer. The kit may also include one or more devices for marking the at least two internal layers with a private key or portion thereof, for example by engraving the key in the internal layers, in a case where the at least two internal layers are initially provided without said private keys already therein. Kits provided herein may further include instructions and/or tools for assembling or securing the present tokens (such as screws, screwdrivers, tamper resistant epoxy or tape, etc).

Further included are methods for assembling an offline cold storage token as described herein, which include providing a token shell, placing at least two internal layers into the token shell, which internal layers each include a private key or portion thereof, adding a top layer over the at least two internal layers such that the private keys or portions thereof are not visible, and securing the top layer and the token shell together (either directly or indirectly) to form an offline token storage token, wherein the token optionally includes a discoverable public key.

### BRIEF DESCRIPTION OF DRAWINGS

Non-limiting example embodiments are described herein, with reference to the following accompanying Figures:

FIG. 1 depicts a non-limiting example of an exploded view of components of a blockchain token in accordance with non-limiting example embodiments of the present invention.

FIG. 2 depicts a partially exploded view of components of the example token of FIG. 1.

FIG. 3 depicts an assembled example token of FIG. 1.

### DETAILED DESCRIPTION OF THE INVENTION

The present invention is directed to offline cold storage tokens and parts thereof, which may be used for maintaining safely, in a physical form, private and public keys that may be used for example, in blockchain currency. Also provided are kits that include one or more components of the present tokens. Further included are methods for assembling an offline cold storage token.

### Definitions

In describing example embodiments, specific terminology is employed for the sake of clarity. However, the embodiments are not intended to be limited to this specific terminology. Unless otherwise noted, technical terms are used according to conventional usage.

As used herein, “a” or “an” may mean one or more. As used herein “another” may mean at least a second or more. Furthermore, unless otherwise required by context, singular terms include pluralities and plural terms include the singular.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments.

As indicated above, cryptocurrency is a digital or virtual currency that uses cryptography for security. Cryptocurrencies use decentralized control as opposed to centralized electronic money and central banking systems. The decentralized control of each cryptocurrency works through a blockchain, which is a public transaction database, functioning as a distributed ledger.

A “blockchain” is a continuously growing list of records, called blocks, which are linked and secured using cryptography. Each block typically contains a hash pointer as a link to a previous block, a timestamp and transaction data. By design, blockchains are inherently resistant to modification of the data. It is an open, distributed ledger that can record transactions between two parties in a verifiable and permanent way. For use as a distributed ledger, a blockchain is typically managed by a peer-to-peer network collectively adhering to a protocol for validating new blocks.

A cryptocurrency “wallet” stores the public and private “keys” or “addresses” which can be used to receive or spend the cryptocurrency. With the private key, it is possible to write in the public ledger, effectively spending the associated cryptocurrency. With the public key, it is possible for others to send currency to the wallet. Cryptocurrency is pseudonymous rather than anonymous in that the cryptocurrency within a wallet is not tied to people, but rather to one or more specific keys (or “addresses”). Keys herein include private keys and public keys. A discoverable public key, may include visible keys, such as an alphanumeric key or portions thereof, and keys that may be discovered in other ways, for example by an RFID, scannable bar code or readable type. Also included are PGP and RSA keys, as well as keys that may be discovered by other methods. Private keys may include for example, codes (such as RFID, Near Field Communication (NFC) or scannable bar codes), alphanumeric keys or other private keys that may not be readily discovered by the persons other than a key holder. Cryptocurrency owners are not identifiable, but all transactions are publicly available in the blockchain.

The present invention is directed to an offline cold storage token, that acts as a “wallet” in that it is a way of consolidating private keys for cryptocurrency in a physical device, and optionally one or more public keys. The present tokens include a token shell, at least two internal layers positioned within the token shell, and a top layer over the at least two internal layers. Each of the internal layers includes a private key or portion of a private key that is not visible when the token is assembled. The token may include a discoverable public key.

A unique aspect of the present invention is the addition of multiple internal layers (disks) to use split list technology to divide the private key into multiple parts, all while concealing the private key and optionally making discoverable a public key or public data.

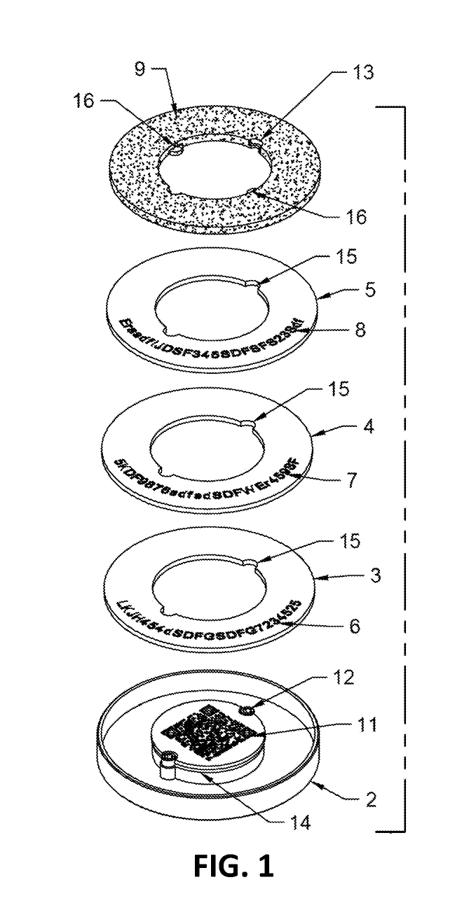

FIG. 1 depicts an exploded view of an example blockchain token 1 (depicted in assembled form in FIG. 3), in accordance with non-limiting example embodiments of the present invention.

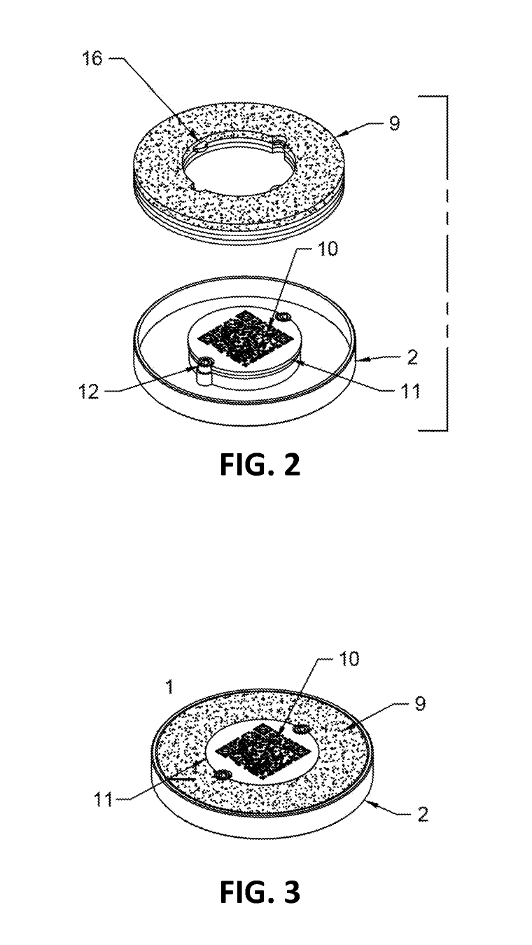

FIG. 2 depicts a partially exploded view of the non-limiting example block chain token of FIGS. 1 and 3. In this view, the internal and top layers are together outside of or detached from a shell 2.

FIG. 3 depicts an assembled blockchain token 1 in accordance with non-limiting example embodiments of the present invention. In particular, FIG. 1 shows a token shell 2, having internal layers therein, which are covered by a top layer 9.

Examples of the present invention may also include at least one securing mechanism to keep the token from disassembling. In the depicted example, a central protrusion 11 of the shell is visible in the assembled token, as it protrudes through openings in the internal layers and top layer. The central protrusion 11, and the top layer 9 may include openings and indentations 13, which are configured to be aligned such that a screw or other fastening device may be inserted therein for securing the shell and layers together. Although two shell openings 12 are shown in FIG. 1, other numbers of openings, and corresponding fasteners (such as screws), are contemplated. Other securing mechanisms are also contemplated, such as hooks, clips, and physical variations in the components that may be configured to fit together to secure the components to one another.

The central protrusion 11 of the token shell, may include a discoverable public key, which may be for example, a visible public key 10, such as a word, phrase, alphanumeric code, QR code 7, and the like, or a key that is not necessarily visible. According to other non-limiting examples, a discoverable public key may be on the bottom of the token shell. Alternatively, the discoverable public key may be a visible key on a visible portion of the top layer. According to non-limiting example embodiments, the discoverable public key is engraved, printed, stamped, or otherwise made discoverable on the token shell or top layer, such that when the token is fully assembled, the public key may be made discoverable. For example, the discoverable public key may be an RFID, NFC, scannable bar code, or other readable key.

According to non-limiting example embodiments, tokens of the present invention may include at least two, three, four, five or more internal layers, and therefore, may include four, five, six, seven or more separate parts when including the shell and top layer. By way of non-limiting example, in embodiments having four component parts, the components may include e.g., a token shell that has an engraved public key (walled ID), two internal layers, which may be copper disks physically stamped with the private key, and a top layer/concealing cap to hide and secure the private key or data required to be kept secret. According to other examples, there may be a different number of internal layers/disks. Also, other materials are contemplated.

An advantage of having multiple internal layers/copper disks, is that each internal layer can be sent via a different courier or courier method to the recipient, to avoid theft of intercept of the transfer. After all of the internal layers/disks are at their final destination, the keys (on the internal layers) can be assembled into a single unit with the token shell and top layer (concealing cap).

As indicated above, FIG. 1 depicts an exploded view of components of the example token 1 of FIG. 3. In particular, a shell 2 is provided having a central protrusion 11, holes (such as holes, which may be configured to accept a fastener such as screws) 12, and a slit 14, which may extend around much or all of the circumference of the central protrusion. Shown in FIG. 1 are three internal layers 3, 4 and 5. Other embodiments may have 4, 5 or more internal layers. The internal layers may each include a private key or portion of a private key, which are not visible when the token is assembled with a top layer over the internal layers.

In the depicted example, the internal layers 3, 4 and 5 are disk shaped, but other shapes are contemplated and may be used in example embodiments. The depicted internal layers 3, 4 and 5 also include indents 15 in this example, which are configured in size and shape to correspond with the shape of the shell and/or top layer 9, to receive a fastener, such as a screw. In the depicted embodiment, the top layer 9 of the token, also has an indent 13, which is configured in size and shape to be aligned with the other indents 15, such that a screw or other fastening device may be inserted in holes 12 of the shell. The top layer also depicts a protrusion 16, which may be used for locking the top layer 9 to a portion of the shell by rotating the protrusion 16 into slits 14 of the shell.

According to non-limiting example embodiments, the shell may include one or more protrusions (such as central protrusion 11 depicted in FIGS. 1-3), which may be of various sizes and shapes and may not necessarily be centrally located in the shell. It is contemplated, that a protrusion may be square or oval and/or may itself include multiple protrusions, depending e.g., on a locking mechanism to be used.

The holes 12, or other configuration that may be used to secure the layers together, may be adapted for receiving a fastener, such as a screw. A slit 14 in the token shell may be used for aiding in keeping the token pieces joined together. It is contemplated that a slit 14 in a protrusion of the shell may be angled such that a protrusion in the top layer enters the slit and is screwed down further into the token, similar to a screw, rather than staying on the same plane.

As shown in the exploded view of FIG. 1, each internal layer includes a private key or portion of a private key (6, 7, and 8 on internal layers 3, 4 and 5, respectively). The present invention provides multiple internal layers in the present tokens.

According to non-limiting example embodiments, the at least two internal layers include at least three internal layers, or at least four internal layers or more internal layers as discussed herein. The unique multiple layers allow an owner to physically transport, mail, ship, and/or courier the split private key in separate parts to avoid reconstruction without the entire keyset. For example, you could mail the parts/keys/layers of the present tokens via three (or four or five, etc. . . . depending on the number of layers) separate methods and reassemble the keys at the other end to avoid theft or tracking. The invention vault can be physically separated into multiple separate pieces for storage, or stored as a single “cold storage token”.

The at least two internal layers may be made of e.g., copper disks, or may be any other suitable material, depending for example, on the purpose for which the layers are being made. By way of example, the token may be a token that is configured to withstand fire and other possible physical destruction in which case the layers and other components of the token may be made of a material that is e.g., fire and water resistant. Present cold storage methods of printing private keys on paper only addresses offline backup of a private key. But such methods leave the keys vulnerable to fire, water and other natural disasters. The currency of the present invention may be made of metal and or material that is fire, water and damage resistant, according to non-limiting example embodiments. The average house fire burns at a temperature of about 1,100 degrees Fahrenheit. Therefore, example tokens of the present invention and components thereof (including the internal layers) can be made of copper, stainless steel, ceramics, and other components that have a melting temperature far greater than 1700 degrees Fahrenheit keeping the contents safe from fire, water, and natural disasters for generations to come.

Another unique aspect of the present invention is that the currency may be made of a rugged material such as metal, ceramic, and or polymers that will physically store the public and private keys on a physical device or “token.” The material of various parts of the present invention may be varied, e.g. based on cost, desired appearance, weight or other desired factors. The material of the internal layers may also be varied depending on how the cryptocurrency is to be added to the token.

In a case in which a token is a high-quality token to be used for example for gift purposes, it may be desirable to have the internal layers (and the shell and/or top layer) be a high quality, heavy and/or aesthetically pleasing material. In a case in which a less expensive token is desired, and/or in which having a disaster proof token is not necessary, the internal layers (as well as other components) may be made of e.g., a plastic or other lesser quality material, that may be for example, less expensive to produce, than other more rugged or aesthetically pleasing expensive materials.

The internal layers may be made of the same or different materials. The layers may also be configured within the present token in a specific arrangement, or they may be interchanged within the token. If a specific arrangement is required or desired, the internal layers may be configured for example with protrusions and corresponding indents or holes for receiving such protrusions, such that the layers may only be stacked within the token shell in a specific order.

Another unique aspect of the invention is the ability to keep (not share) a private key to a third party to engrave on a card. According to example embodiments, the private keys in the present invention (often a 51-character word/number string, or 24 word mnemonic but not limited thereto) can be hand punched onto, or otherwise added to, the copper inner layers or disks by the token owner. According to example embodiments, the inner layers may either be sent separately or together with private keys or portions thereof already engraved, printed or stamped on the internal layers. Or the present invention may provide internal layers that are made of a material and/or configured such that they allow an owner or other user to stamp, print, or otherwise label the internal layers e.g., with a letter embossing stamp to permanently mark the layers/disks without sharing the secret key or data with a third party. This greatly enhances keys security over existing methods.

As with the internal layers, the material of the top layer may be selected based e.g. on the desired purpose of the tokens. For example, the material may be selected to be fire proof, water proof, scratch proof, aesthetically pleasing, etc depending on the intended use. Or the material may be selected to be a less expensive material if desired. The material may also be selected to be a material that may be easily engraved or printed on, or may be of a suitable material to maintain a public key or logo thereon without scratching or other damage. In other non-limiting example embodiments, the top layer may not have any engraving or printing. Because a portion of the top layer is visible, the layer may be of a material, shape or configuration that may be desired for aesthetics, feel and/or grip of the token.

The projections 16 in the top layer 9 may be positioned such that they may be inserted into a slit 14 in the shell 2 and rotated to secure the top layer to the shell as described herein. The top layer may also include one or more indents 13, which may be aligned with corresponding indents 15 in the internal layers and the token shell so as to create a hole for receiving a fastening device.

While FIG. 2 shows the layers together, the internal layers and top layer may be inserted into a token shell together or individually.

As described herein, the top layer of the token may be configured such that it has one or more protrusions 16 (which may be of various shapes, lengths, widths or thicknesses), which are adapted to be inserted into or rotated into a slit within the token shell to secure top layer to the token shell, having the at least two internal layers therebetween.

As indicated above, the present tokens may also include at least one securing mechanism, such as a screw, in addition to, or instead of physical method of securing layers together. According to example embodiments, the parts of the token (e.g. the token shell, at least two internal layers, and the top layer) are configured to be capable of receiving one or more screws to secure the layers and token shell together.

If the user is concerned about tampering, according to non-limiting example embodiments, the present tokens may further include a tamper resistant component, device or method. In particular, the tokens may have tamper-resistance devices or components to secure the token from being disassembled (or from being disassembled without one being alerted to tampering). By way of example, screws or other securing devices may be treated with e.g., a tamper resistant epoxy or other tamper resistant device or component (such as tape), to prevent or show any tampering.

Also included herein are kits for an offline cold storage token that include a token shell, at least two internal layers adapted to fit within the token shell, a top layer adapted to fit over the at least two internal layers, and optionally a discoverable public key, e.g., on a portion of the token shell or top layer. The components of such kits may be as described herein with respect to other embodiments. For example, kits may also include one or more components for securing the top layer, the at least two internal layers and the token shell together.

According to example embodiments, kits provided herein may include unmarked internal layers. Such kits may further include one or more devices or components for marking the at least two internal layers with a private key or portion thereof, for example by engraving the private key or portion of the private in the internal layers.

Example kits may also include one or more of instructions and/or tools for assembling and/or securing the present tokens (such as screws, screw drivers, and/or tamper-resistant epoxy or tape).

Further included are methods for assembling an offline cold storage token, which include providing a token shell; placing at least two internal layers within the token shell, which internal layers each include a private key or portion thereof; placing a top layer over the at least two internal layers, and securing the top layer, at least two internal layers, and the token shell together to form an offline cold storage token, wherein the token may include a discoverable public key. It should be noted that the internal layers may be placed in the token shell together or individually, and the top layer may be placed over the top of the internal layers either before the internal layers are added to the shell or after.

It should also be noted, that according to non-limiting example embodiments, further components may be added to the token (e.g., between the shell and the top layer) if desired by the user. For example, thin layers of material may be added (such as between plates) to prevent noise or abrasion of layers (such as metal layers) rubbing together. Alternatively, a powder or liquid may be present within the token as may be appropriate (e.g. for preservation). Further, written materials may be provided with or within the token (e.g. on paper or material), as may be appropriate to maintain and/or provide further information about the token and/or data therein.

The components of such methods may be as described herein with respect to other embodiments. As with other embodiments herein, the at least two internal layers may include at least three internal layers, four or more layers. The at least two internal layers may include copper disks or layers of other materials and/or shapes.

Example methods may also include one or more components for securing the top layer, the at least two internal layers and the token shell together. As with other embodiments, the top layer may include one or more protrusions. In example embodiments, securing may include positioning the top layer such that the one or more protrusions are aligned with a slit within the token shell, and rotating the top layer or the token shell such that the one or more protrusions fit within the slit to secure the top layer to the token shell, for example, with the at least two internal layers therebetween. The securing mechanism may also include one or more screws or other securing mechanisms.

According to example methods, in the process of being disassembled (or assembled), after screws are removed or before they are attached, (when the screws are not in place), the top layer may be rotated with respect to the shell, or the shell rotated with respect to the top layer, to disengage the protrusions of the top layer from the slit in the shell, or to engage the protrusions of the top layer with the slit in the shell. After rotation to disengage the protrusion, the top layer and internal layers underneath may be removed from the shell.

As with other example embodiments, a discoverable public key may be included, which may be a visible public key which may be for example, engraved, printed or stamped on the token shell or top layer. Alternatively, the discoverable public key may be an RFID, scannable bar code, or other readable key. A tamper resistant component such as an epoxy may be added over said securing mechanism in the example methods.

It also should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

The present invention should not be considered to be limited to any particular color, design or material.

It should be understood that the present tokens may be provided in various shapes and sizes, and thicknesses. By way of non-limiting example, the general shape may be circular, but the token is not limited to a circular/round shape. It is also contemplated that according to non-limiting example embodiments, the size may be such that the tokens may fit in casino chip holders, and therefore may be used in casinos. Additionally, it is contemplated that the token shell, internal layers, top layer and/or overall token may be square or rectangular or other shapes. Further, the overall width and width of each component part or layer may be varied. According to non-limiting examples, the shell and layers may be rectangular in shape, and the layers may be of a thickness, such that the overall token forms a shape similar to a card (e.g., similar to a credit card in size, shape and/or thickness).

As is apparent from the present specification, the present invention includes fire-proof, water-proof, hacker-proof, and/or natural disaster-proof devices, methods and systems, that allow the secure physical shipment and storage for crypto/blockchain currencies.

The bottom of the present tokens may be plain, decorative, and/or may include the public key (e.g., if the public key is not elsewhere on the token). The shape may also be varied for example with an indent in the bottom of the shell, to more easily hold the token, e.g. with one's finger or thumb, and/or to aid with rotation of the layers and/or opening of the token.

It should be understood that the layers of the present tokens are exemplary and may vary in the order, configuration, physical structure and materials from those described herein. Thus, the present configurations should be understood to be merely exemplary. Likewise, additional layers or other components may be included in such tokens, and certain layers or components may be omitted or combined, consistent with various embodiments of the present invention. Further, methods of securing the token components to one another may be varied within the scope of the present invention.

The embodiments illustrated herein and below are not intended to be exhaustive or to limit the invention to the precise form disclosed. These embodiments are chosen and described to best explain the principle of the invention and its application and practical use and to enable others skilled in the art to best utilize the invention.

### EXAMPLES

### Example 1

According to a non-limiting example embodiment of the present invention a token is provided as depicted in FIGS. 1-3 that generally includes a shell 2, two or more internal layers (3-5), and a top layer 9. In this example, each of the top and internal layers has indents (15 and 13), which may be aligned and configured such that screws may be added to hold the layers of the token together.

The shell includes a central protrusion having two screw holes 12 and a slit 14. It should be recognized that the number of screw holes is not limiting, nor is the slit size or configuration, so long as the present goals of holding the token together via screws, via top layer protrusions 16 being inserted in the slit 14, or by other method, are met. Additional protrusions may be present on the token shell of this example token. Such protrusions may be useful for example, for assisting in alignment of the layers and securing them in place, by aligning indents in the internal layers with protrusions of the shell. The number and shape of any protrusions is not limited, so long as any indents in the internal layers are able to fit with the protrusions to meet the purpose of holding the internal layers within the shell.

It can be seen from the figures that the internal layers in this example embodiment each have a central hole, which is configured in size and shape to fit around the central protruding portion of the shell.

As indicated above, in this example token, the top layer 9 includes protrusions 16 which fit within the slit 14 of the shell. In the assembly of the token, the internal layers 3-5 may be aligned within the shell by directly placing them within the shell, aligning the indents in the layers with protrusions in the shell, which may be created e.g., for such placement of the internal layers 15 and/or may be created as a result of creating screw holes or other fastening configurations. The top layer 9 is positioned on the top of the internal layers (3-5) with the protrusions 16 aligned with indents in the center portion of the shell over the top of the screw holes, such that the protrusions 16 may be introduced to the slit 14. The top layer 9 may then be rotated with respect to the shell such that the protrusions 16 slide within and are engaged in the slit 14. According to example embodiments, the top layer 9 is rotated until indents 13 in the top layer are aligned with indents 15 in the internal layers, over the openings and screw holes in the shell, such that screws may be screwed through the indents and holes into the shell 2.

### Example 2

According to another non-limiting example of a token in accordance with non-limiting example embodiments, a token is provided in which a central protruding portion 11 of the shell is visible when the token is fully assembled. This central protruding portion 11 is configured in shape to assist with holding the internal layers and top layer in place. By way of example, the shell may be configured to have holes configured to receive hex screws, such as three hex screw-holes, and three hex screws are used to hold the layers together in this example.

As with other examples, in this example token, the shell and top layer may be made of different material and/or have different designs and markings, within the scope of the present invention. Additionally, indents in the layers and protrusions in the shell may be varied within the scope of the present invention.

### Example 3

According to another non-limiting example embodiment, a token is provided in which the shell has multiple protrusions (such as three) along the circumference of the shell, which correspond to three indents along the outside of each inner layer. The shape of the central protrusion of the shell in this example is not perfectly circular, due to the configuration of screw holes in the shell. The internal holes of each internal layer/disk are therefore also not perfectly circular, to provide screw holes. Further provided in this example is a top layer configured to be added on top of the internal layers when the token is assembled. The top layer also provides indents to be aligned with indents of the internal layers and the central protrusion for insertion of three fastening screws to hold the tokens together. The top layer in this example also includes protrusions for fitting within a slit of the shell to aid in holding the layers of the token together when the token is assembled.

In this example, screws are used to fasten together the tokens layers.

Although the invention has been described in detail and with reference to specific embodiments, it will be apparent to one skilled in the art that various changes and modifications can be made without departing from the spirit and scope of the invention. Thus, it is intended that the invention covers the modifications, variations, and equivalents of this invention. It is also intended that the components of the various devices disclosed above may be combined or modified in any suitable configuration.

What is claimed is:

1. An offline cold storage token, comprising:
a token shell,
at least two internal layers positioned within said token shell, wherein each internal layer includes a private key or portion of a private key that is not visible when the token is assembled, and
a top layer positioned and secured over said at least two internal layers.

2. The offline cold storage token of claim 1, wherein said token further comprises a discoverable public key.

3. The offline cold storage token of claim 2, wherein the discoverable public key is engraved, printed, or stamped on the token shell or top layer.

4. The offline cold storage token of claim 1, wherein said at least two internal layers comprise at least three internal layers.

5. The offline cold storage token of claim 1, wherein said at least two internal layers comprise copper disks.

6. The offline cold storage token of claim 1, further comprising at least one securing mechanism to secure the token shell, internal layers and the top layer together.

7. The offline cold storage token of claim 6, wherein the securing mechanism comprises one or more screws; and wherein the token shell, at least two internal layers, and the top layer are configured to be capable of receiving the one or more screws to secure the layers and token shell together.

8. The offline cold storage token of claim 1, wherein the top layer comprises one or more protrusions adapted to be rotated into a slit within the token shell to secure the top layer to the token shell.

9. The offline cold storage token of claim 1, further comprising a tamper-resistant component.

10. The offline cold storage token of claim 9, wherein the tamper resistant component comprises a tamper-resistant epoxy.

11. A kit for an offline cold storage token comprising
a token shell,
at least two internal layers adapted to fit within said token shell, and
a top layer adapted to fit over said at least two internal layers.

12. The kit of claim 11, further comprising one or more components for securing said top layer, at least two internal layers, and said token shell together.

13. The kit of claim 11, further comprising one or more components for marking the at least two internal layers with a private key or portion thereof.

14. The kit of claim 11, further comprising instructions or tools for assembling said token.

15. A method for assembling an offline cold storage token, comprising:
providing a token shell,
placing at least two internal layers into said token shell, wherein each internal layer includes a private key or portion thereof,
placing a top layer over the at least two internal layers such that the private keys or portions of private keys are not visible, and
securing the top layer, at least two internal layers, and the token shell together to form an offline cold storage token.

16. The method of claim 15, wherein said token includes a discoverable public key.

17. The method of claim 15, wherein said at least two internal layers comprise at least three internal layers.

18. The method of claim 15, wherein the top layer comprises one or more protrusions.

19. The method of claim 18, wherein said securing comprises
positioning said top layer such that the one or more protrusions are aligned with a slit within the token shell, and
rotating the top layer or the token shell such that the one or more top layer protrusions fit within the slit to secure the top layer to the token shell.

20. The method of claim 15, further comprising adding tamper resistant component to the token.
